(19) United States
(12) Patent Application Publication
(10) Pub. No.: US 2010/0034967 A1
(43) Pub. Date: Feb. 11, 2010

(54) DRY POLYMER LAYERING USING A ROTOR PROCESSOR

(75) Inventors: SHAWN M. ENGELS, TIPTON, IA (US); BRIAN K. JENSEN, CEDAR RAPIDS, IA (US)

Correspondence Address: MCKEE, VOORHEES & SEASE, P.L.C., 801 GRAND AVENUE, SUITE 3200, DES MOINES, IA, 50309-2721, US

(73) Assignee: VECTOR CORPORATION, MARION, IA (US)

(21) Appl. No.: 12/512,374

(22) Filed: Jul. 30, 2009

Related U.S. Application Data
(60) Provisional application No. 61/087,089, filed on Aug. 7, 2008.

(51) Int. Cl. B05D 1/12

(52) U.S. Cl. 427/180

(57) ABSTRACT

The method for applying a dry polymer layer to particulate cores circulating as a bed in a rotor processor includes the steps of loading the cores into the processor, rotating the rotor of the processor and supplying air into the processor to create the bed, spraying the cores with a wetting agent, and supplying dry polymer powder into the bed so as to adhere onto the wetted cores and thereby build up a continuous smooth layer of polymer on the cores. The wetting agent includes a plasticizer so as to facilitate uniform layering of the micronized polymer powder.

### CROSS-REFERENCE TO RELATED APPLICATIONS

This application claims priority under 35 U.S.C. §119 of a provisional application Ser. No. 61/087,089 filed Aug. 7, 2008, which application is hereby incorporated by reference in its entirety.

### FIELD OF THE INVENTION

This invention is directed towards a rotor process for coating or layering micronized particles with a polymer in a rotor processor. The polymer is generally from the methacrylate family of related polymers, including copolymers and monomers.

### BACKGROUND OF THE INVENTION

Powder layering or layering of small particulates, commonly known as cores, beads, crystals, pellets, granules or seeds, is well known for creating spherical particles, such as pharmaceuticals. The typical size for such particles is 50-10,000 microns. A rotor processor is commonly used for such layering. This processor has a cylindrical stator chamber with a rotatable disc mounted therein, and a narrow annular slit between the inner wall of the stator and the perimeter edge of the rotor. The rotor forms a floor in the stator chamber upon which particles are supported. The width of the slit is sufficiently narrow so as to prevent particles in the chamber from falling through the slit. Rotation of the rotor imparts centrifugal force to the particles, which are thrown to the wall of the stator, wherein air forced upwardly through the slit lifts the particles upwardly. The width of the slit governs the air velocity for a given airflow, which creates an upward draft which carries the particles upwardly. The upward movement of the particles continues, as long as the air velocity exceeds the transport velocity required to circulate the particles. The air passing through the slit has a relatively high velocity, and then expands into the larger volume of the chamber, thereby losing velocity. As the particles lose their transport velocity, they fall back toward the center of the rotor and return to the rotor surface. Thus, the rotating rotor and the upwardly flowing air create a rotating bed of particles within the chamber.

The particles are coated or layered during circulation through the bed. In the conventional layering process, a polymer, copolymer or monomer is dissolved in a solvent, which is then sprayed onto the particles in the chamber while the particles are circulating. The airflow also functions to dry the solution on the cores, with the layer thickness being built up as the particles continue circulating through the bed for repeated exposure to the sprayed polymer solution.

With the conventional polymer coating/layering process, the polymers must be soluble so as to dissolve in a suitable solvent so as to be applied as a dilute liquid. Typical soluble polymers will be 5-15% solids in solution, by weight. In a pharmaceutical application, the polymers may function for modified release of active ingredients and/or for taste masking. In this type of application, polymers may be layered on the cores for 5-25% weight gain. In the case of organic solvent soluble polymers, as much as 5 kg of solvent must be used for each 1 kg of product coated. In scaled production, this is a very large amount of solvent per coated batch. For example, in a 5 kg batch of cores coated to a 25% weight gain with a 5% solids solution, a 25 kg solution is required, with the polymer application being approximately 2.5 grams of polymer substances per minute. Thus, the conventional layering process with dissolved polymers in solvent solution is slow and requires large volumes of solvents.

Accordingly, a primary objective of the present invention is the provision of an improved bead layering process using dry polymer in a rotor processor.

Another objective of the present invention is the provision of a dry polymer layering process for particles using a rotor processor so as to overcome the deficiencies and problems of conventional solvent/polymer solution layering processes.

Still another objective of the present invention is an improved method for applying polymer layers to particulate cores in a rotor processor.

Still another objective of the present invention is the provision of a method of applying polymer layers to cores in a rotor processor without a solvent.

Another objective of the present invention is the provision of a polymer layering process where dry polymer powder is applied to wetted cores in a circulating fluidized bed of cores within a rotor processor.

Yet another objective of the present invention is a method of forming pharmaceuticals wherein fluidized cores in a rotor processor are wetted, layered with dry polymer powder, and air dried while circulating through the processor chamber.

A further objective of the present invention is the precise control of very small amounts of slit air to allow precise location of small cores and micronized powders in a rotor processor.

Another objective of the present invention is the provision of a method of applying a polymer layer to a bed of particulate cores which is efficient and economical.

These and other objectives will become apparent from the following description of the invention.

### SUMMARY OF THE INVENTION

In the method of applying polymer layers to particulate cores in a rotor processor, the cores are loaded into the processor. The rotation of the processor rotor and the geometry of the rotor and the radius of the stator creates a uniform and ordered flow of cores on the rotor, and past the spray gun and powder feed port. The precisely controlled low volume of air flowing through the slit gap keeps product from falling through the gap. The circulating cores are sprayed with a wetting agent and a dry polymer powder is injected into the stator so as to form a layer on the wetted cores. As the cores continue to circulate through the rotating bed, the wetting and layering process continues until the desired amount of mass has been added to the cores. The wetting agent may include a plasticizer which enhances the polymer layering on the cores. The polymer is injected in the form of a dry micronized powder. No solvent is used in this layering process.

### DETAILED DESCRIPTION OF THE PREFERRED EMBODIMENT

The dry polymer layering process is best suited for a rotor processor, such as the GX or GXR sold by Applicant, or a modified GX or GXR, which is described in co-pending patent application Ser. No. 12/509,513 filed on Jul. 27, 2009 and entitled IMPROVED ROTOR PROCESSOR FOR DRY POWDERS, which is incorporated herein by reference. Another example of a suitable rotor processor is that described in Applicant's co-pending application Ser. No. 11/669,544 filed on Jan. 31, 2007 and incorporated herein by reference. The rotor processor includes a stationary container or stator with a rotatable rotor mounted therein to define a rotor chamber. A drive assembly drivingly connects the rotor to a motor. The processor further includes one or more spray guns to introduce a wetting agent into the rotor chamber and one or powder feed systems to introduce the dry glidant powder into the rotor chamber. Preferably, the spray and powder ports are located in the stator wall adjacent the upper edge of the concave rotor at circumferentially spaced positions, so as to define separate spray and powder zones in the rotor chamber. Also, the powder feed system is connected to a pressurized air source so as to supply the powder at a positive pressure into the rotor chamber. A sample port may be provided in the processor, along with a window to observe the interior of the container during the layering operation. A product discharge port is provided in the stator to remove the finished, coated particles from the processor.

In the process of the present invention, the cores to be coated are loaded into the rotor chamber, and the processor is actuated to create a uniform helically rotating ordered flow for the particulate cores. The centrifugal force created by the rotating rotor and the air flowing upwardly through the gap between the outer perimeter edge of the rotor and the wall of the stator causes the particles to circulate upwardly adjacent the wall and downwardly along the central axis of the rotor chamber. During this circulation, the spray gun sprays a solution onto the cores so that the cores become wet. The powder feed system, which is spaced apart from the spray guns, introduces dry polymer powder which adheres to the wetted cores. Thus, the polymer powder is introduced into the rotating bed, rather than through, over or onto the core bed. The spacing and location of the powder port relative to the spray gun eliminates or minimizes agglomeration of both the core particles and the injected coating materials. The powder port location, airflow control, and concave or disc shaped rotor also increases uniformity of the layering and minimizes powder loss during the process.

The particles pass repeatedly and sequentially through the spray and powder zones. The upwardly flowing air through the slit also functions to evaporate the solution, leaving a polymer layer on the cores. Additional drying air is introduced into the processor from above the bed, to further enhance evaporation. The delivery of a large amount of drying air from the top of the particle bed allows for rapid evaporation of the coating solution, while keeping the cores in contact with the rotor plate and maintaining the small gap between the rotor and the stator.

As the circulation of the cores continues, a continuous layer is built up to a desired thickness on the cores.

The polymer may be selected from a group consisting of HPC, EC, HPMC AS, and polyoxyethelene. Preferably, the polymer is micronized before introduction into the processor 10. The wetting solution preferably includes a plasticizer to enhance the buildup of uniform film layers onto the cores. The wetting agent may also include water, solvent and/or binder. Preferably, the plasticizer constitutes 1-100% of the wetting solution. The plasticizer may be either miscible or non-miscible, and may include an emulsifier or surfactant. Also, the spray guns preferably atomize the wetting agent for complete wetting of the core surfaces.

During the layering process, the cores circulate cyclically through the wetting zone and layering zone so as to build up multiple, uniform polymer layers on the cores. The cycles repeat until a desired thickness is achieved. The processor 10 is then shut down, and the coated cores can be emptied or discharged from the container 12.

In pilot and feasibility testing, successful layering of cores was achieved using the following parameters. It is understood that for production scale, the parameters may vary.

During the layering process, the polymer powder was introduced at 10-100 psi, at a rate of approximately 1-20 grams per minute.

During the wetting step, the solution was sprayed onto the cores at a rate of approximately 1-30 grams per minute.

The air flowing through the slit and into the container 12 was introduced at a rate of approximately 5-10 cubic feet per minute and a temperature of 20-80° C. The air facilitates drying of the polymer on the wetted cores. The air is exhausted from the container 12 at a temperature of approximately 10-40° C.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A method of applying a polymer layer to a circulating bed of particulate cores in a rotor chamber of the rotor chamber, comprising:
loading the cores into a rotor processor;
actuating airflow in the processor and rotating the processor rotor so as to circulate the cores in the chamber;
wetting the circulating cores; and
introducing dry powder polymer material into the rotor chamber so as to adhere to the wetted cores and form a layer on the cores.

2. The method of claim 1 wherein the polymer is micronized before introduction into the chamber.

3. The method of claim 1 wherein the wetting step uses a liquid selected from a group consisting of water, solvent, binder and plasticizer.

4. The method of claim 1 wherein the wetting step uses a solution of water and plasticizer.

5. The method of claim 4 wherein the solution is 1-100% plasticizer to water.

6. The method of claim 4 wherein the plasticizer is miscible.

7. The method of claim 4 wherein the plasticizer is non-miscible and the solution further includes an emulsifier or surfactant.

8. The method of claim 1 wherein the wetting step uses a solution of solvent and plasticizer.

9. The method of claim 1 further comprising rotating a rotor in the processor at 150-450 rpm.

10. The method of claim 1 wherein the powder polymer is introduced under positive air pressure.

11. The method of claim 1 wherein the cores repetitively and sequentially cycle through separate wetting and powder zones in the rotor chamber to build up a continuous layer on the cores until a desired thickness is achieved for the layer.

12. The method of claim 1 wherein the wetting of the cores is by an atomized spray of liquid droplets.

13. The method of claim 1 wherein the powder is introduced at 10-100 psi.

14. The method of claim 1 wherein the powder is introduced at 1-20 grams per minute.

15. The method of claim 1 wherein the wetting step comprises spraying a liquid at a rate of 1-30 grams per minute onto the cores.

16. The method of claim 1 wherein the airflow is 5-10 cfm.

17. The method of claim 1 wherein air for the airflow is introduced into the processor at 20-80° C.

18. The method of claim 17 further comprising exhausting air from the processor at 10-40° C.

19. The method of claim 1 wherein the polymer is selected from a group consisting of HPC, EC, HPMC AS, and polyoxyethelene.

20. A method for applying a polymer layer to particulate cores circulating in a rotor processor, comprising:
spraying the circulating cores with a wetting agent; and
supplying dry polymer powder into the processor so as to adhere onto the wetted cores and thereby build up a continuous smooth layer of polymer on the cores.

21. The method of claim 20 wherein the wetting agent includes a plasticizer.

22. The method of claim 20 further comprising rotating the rotor of the processor at 150-450 rpm, introducing the powder into a rotor chamber of the processor at a rate of 1-20 grams per minute and a pressure of 10-100 psi, spraying the wetting agent into the rotor chamber at a rate of 1-30 grams per minute, and supplying the air into the rotor chamber at a rate of 5-10 cfm and a temperature of 20-80° C.
